(19) United States
(12) Patent Application Publication
(10) Pub. No.: US 2026/0141889 A1
(43) Pub. Date: May 21, 2026

(54) Apparatus for Generating Tones with Projectiles, Particles or Gases

(71) Applicant: Couvillion Patents, LLC, Lafayette, LA (US)

(72) Inventor: ROY J. COUVILLION, LAFAYETTE, LA (US)

(21) Appl. No.: 18/947,572

(22) Filed: Nov. 14, 2024

Related U.S. Application Data
(63) Continuation-in-part of application No. 18/918,582, filed on Oct. 17, 2024.
(60) Provisional application No. 63/598,972, filed on Nov. 15, 2023.

(51) Int. Cl. G10K 15/04; F41A 21/32

(52) U.S. Cl. CPC G10K 15/043; F41A 21/32

(57) ABSTRACT

An apparatus using energy generated by a firearm or any other device capable of propelling a projectile at high velocities, including gases and particles and projectiles, to create a desired sound, whether used in conjunction with other devices or not. An apparatus adapted to exploit energy, such as the energy created by projectiles, particles, gases, or mechanical energy used to propel them, to create tones or sounds at specific frequencies and ranges of frequencies. An apparatus adapted to harness energy from a firearm or a projectile to generate sounds at specific frequencies or ranges of frequencies and to adapt to a variety of different environmental conditions.

### CROSS REFERENCES TO RELATED APPLICATION

PRIORITY OF U.S. Provisional Patent Application Ser. No. 63/598,972, FILED Nov. 15, 2023, INCORPORATED HEREIN BY REFERENCE, IS HEREBY CLAIMED. THIS APPLICATION IS ALSO A CONTINUATION-IN-PART OF application Ser. No. 18/918,582, FILED Oct. 17, 2024, INCORPORATED HEREIN BY REFERENCE, CURRENTLY PENDING.

### STATEMENTS AS TO THE RIGHTS TO THE INVENTION MADE UNDER FEDERALLY SPONSORED RESEARCH AND DEVELOPMENT

NONE

### BACKGROUND OF THE INVENTION

### Field of the Invention

The field of this invention generally relates to the field of firearms, sound suppressors, silencers, flash suppressors, blast diverters, muzzle brakes, and other muzzle devices for firearms and devices capable of propelling a projectile at high velocities. More particularly, the field of this invention relates to an apparatus that can use energy generated by a firearm, including high-velocity gases and particles and projectiles, to create a desired sound, whether used in conjunction with other devices or not. More particularly still, the present invention pertains to an apparatus that is adapted to exploit energy, such as the energy created by projectiles, particles, gases, or mechanical energy used to propel them, to create tones or sounds at specific frequencies and ranges of frequencies.

### Brief Description of the Prior Art

Firearm sound control and manipulation have historically focused on reducing the audible blast, visual flash, and reactive effect of the blast and projectile ejection on the weapon and shooter. There are obvious benefits in reducing these effects in sport shooting and hunting and for defense, law enforcement, and military applications. The firearm industry has and continues to improve performance parameters with varying degrees of success and progress.

While the science of firearm muzzle blast management typically focuses on sound reduction, sound generation is another productive use of the energy created by a firearm or a projectile. In his May 21, 2009 presentation for the National Defense Industrial Administration, SOUND SUPPRESSOR SPECIFICATION AND SOUND MEASUREMENT, Owen Cramer of the Science Applications International Corporation Naval Surface Warfare Center explained the potential benefit of exploiting the ability to use a firearm to generate sound. In that presentation, Mr. Cramer explains that audio location, also known as sound localization, is the ability of a person to locate the source of a sound, depending on the observer's position. The brain identifies both Interaural Time Differences (ITDs) and Interaural Intensity Differences (IIDs) of sounds that both ears perceive. These differences allow the observer to determine the direction of the source of a sound. Research on in-ear monitors (IEMs) shows that some frequencies cause harmonic resonance in the observer's ear canal. The resonance confuses sound localization; in some conditions, the observer perceives the source to originate behind the head. As such, a firearm that is capable of producing such sounds to create misdirection and positional deception can provide a significant advantage in armed combat and in other military applications. In the presentation, Mr. Owen states that the then-current method does not address that capability.

The present invention provides for an apparatus that has a unique ability to harness energy from a firearm or a projectile to generate sounds. Also unique to the present invention is the ability to design or adjust the apparatus to generate sounds at specific frequencies or ranges and adapt them to a variety of environmental conditions.

### SUMMARY OF THE INVENTION

The present invention pertains to an apparatus that is adapted to generate tones or sounds at specific frequencies using a plurality of energies created by ejected gases, particles, projectiles, and energies from a source, such as a firearm. The apparatus of the present invention can be used with a firearm or other devices capable of propelling a projectile. The apparatus of the present invention can be independent of, used in conjunction with, or combined with other devices, such as, for example, a silencer, a muzzle break, a blast director, a vibration absorber, a flash hider, or any other muzzle device.

In a preferred embodiment, the apparatus of the present invention operates on the principle that an object, when forced into resonance vibrations, vibrates at one of the natural frequencies specific to that object. These frequencies are known as harmonic frequencies, or harmonics. A column of air can produce resonant waves at a fundamental frequency and harmonics. The resonant frequencies and harmonics produced are a function of the geometry of an air column in a cylinder. For example, in a preferred embodiment, an acoustic generator that defines the air column is generally a cylindrical tube, cone, or horn of a round or other geometric cross-section having a constant or variable dimension and open on either one end or both ends, or by a plurality of tines having equal or differing lengths.

It is to be noted that in the context of this application, the cylinder will hereinafter be referred to as a “cylinder” or having a “cylindrical” shape without regard to a specific geometry. In the context of this application, the column of air or firearm blast gases is hereinafter referred to as a “medium” without regard to a specific material. In the context of this application, any energy exciting the cylinder or medium is referred to as “energy” without regard to the source, unless further specified herein. In the context of this application, the accepted tenets of the study of vibrations are considered common knowledge; specific references otherwise will be cited herein, where applicable.

The tone generator apparatus of the present invention utilizes a plurality of energies, such as those found in a firearm, to create sounds at controlled frequencies. The apparatus of the present invention can generate sounds at a specific frequency, multiple particular frequencies, and ranges. Further, the apparatus of the present invention can also have reconfigurable or variable geometries to customize a frequency response or compensate for a variety of different changing conditions. Each tone generator apparatus can comprise a plurality of various features that are adapted to facilitate increased sound amplitude, projection, and direction.

The tone generator apparatus of the present invention can also be adapted as an attachment to or an integral part of a muzzle blast or flash protector. In this context, the energy of any expelled gases become an energy source for sound that is produced by said tone generator apparatus of the present invention. Moreover, several existing and current suppressor designs can be modified and adapted such that the modification results in the formation of a tone generating air column at a projectile exit end of the modified suppressor.

### BRIEF DESCRIPTION OF THE DRAWINGS/FIGURES

The foregoing summary, as well as any detailed description of the preferred embodiments, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

FIG. 1a depicts a side perspective view of a preferred embodiment of a cylindrical tube member of a tone generator apparatus of the present invention attachably connected to a silencer.

FIG. 1b depicts a side perspective view of a preferred embodiment of a cylindrical tube member of a tone generator apparatus of the present invention attachably connected to a muzzle brake.

FIG. 2 depicts a side perspective view of a preferred embodiment of a cylindrical tube member of a tone generator apparatus of the present invention attachably connected to a firearm directly.

FIG. 3a depicts a longitudinal sectional view of an alternate embodiment of a cylindrical tube member of a tone generator apparatus of the present invention, illustrating supersonic shock wave propagation at a plurality of discrete points in a projectile pathway.

FIG. 3b depicts a side perspective view of an alternate embodiment of a cylindrical tube member of a tone generator apparatus of the present invention, illustrating the transfer of energy of a supersonic shock wave to said cylindrical tube member.

FIG. 4 depicts a longitudinal sectional view of an alternate embodiment of a cylindrical tube member of a tone generator apparatus of the present invention, illustrating the transfer of energy from compression in a laminar flow of a projectile in a compressible medium to said cylindrical tube member.

FIG. 5 depicts a longitudinal sectional view of an alternate embodiment of a cylindrical tube member of a tone generator apparatus of the present invention illustrating turbulence and cavitation in a medium caused by a passing projectile.

FIG. 6 depicts a longitudinal sectional view of an alternate embodiment of a cylindrical tube member of a tone generator apparatus of the present invention, illustrating a plurality of rapidly expanding muzzle gases within said cylindrical tube member.

FIG. 7 depicts a longitudinal sectional view of an alternate embodiment of a cylindrical tube member of a tone generator apparatus of the present invention, illustrating a plurality of particles traveling at a supersonic velocity and creating a plurality of individual shockwaves.

FIG. 8 depicts a perspective view of an alternate embodiment of a tone generator apparatus of the present invention comprising a plurality of tines.

FIG. 9a depicts a perspective view of an alternate embodiment of a tone generator apparatus of the present invention comprising a plurality of cylinders.

FIG. 9b depicts a longitudinal sectional view of an alternate embodiment of a tone generator apparatus of the present invention comprising a plurality of cylinders.

### DETAILED DESCRIPTION OF A PREFERRED EMBODIMENT

Referring to the drawings, the present invention comprises a tone generator apparatus 100 adapted for use with a firearm 104 or a firearm suppressor 102, wherein said tone generator apparatus 100 is intrinsic to or attachably connected to an end of a barrel of a firearm or to an end of a device otherwise affixed to the barrel of the firearm. The tone generator 100 redistributes energy that is generated by the firearm 104 after a projectile 103 has been released in order to create a desired tone. Energies that are produced by expanding gases, fluid wakes, cavitations, shockwaves created from an ejected particle or projectile 103, and energies within the firearm 104 and silencer 102 are transferred to a medium and/or a tube member 110 in order to produce sound.

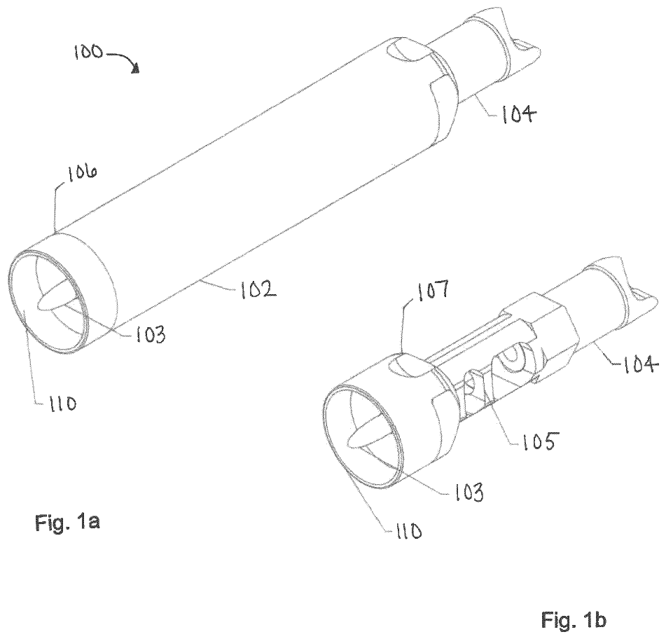

FIG. 1 depicts a tone generator apparatus 100 generally comprising a tube member 110. For purposes of this application herein, tube member 110 comprises a substantially cylindrical shape, having a first end 111 and a second end 112. Additionally, although not depicted in FIG. 1, tube member 110 further comprises an internal channel 115 that is axially aligned with a projectile pathway 114 from a firearm 104, or any other device that is otherwise connected to or affixed to an end of a barrel of a firearm 104. It is to be noted that a tube length 118 and a tube diameter 119 of tube member 110 can vary depending on the desired frequency that is to be created.

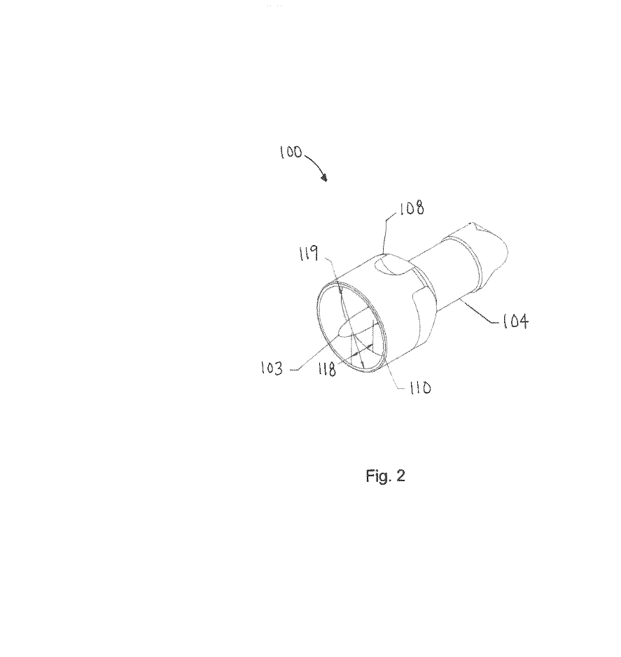

As depicted in FIG. 1a, said second end 112 of tube member 110 of tone generator 100 is attachably connected to and can be utilized as an attachment to or an integral part of a projectile exit end 106 of a firearm silencer 102, or, as depicted in FIG. 1b, as an attachment to or an integral part of a projectile exit end 107 of a muzzle brake 105, or any other device attached to a firearm 104. Additionally, although not depicted in FIG. 1a or 1b, in an alternate embodiment, said tube member 110 can also be an intrinsic feature of firearm 104. By way of illustration, but not limitation, second end 112 of tube member 110 of tone generator 100 can be attachably connected to silencer 102, muzzle brake 105, or firearm 104 (as depicted in FIG. 2), by way of a threaded connection, or any other similar means of attachment. FIG. 2 depicts tone generator 100 generally comprising tube member 110, wherein said second end 112 of tube member 110 of tone generator 100 is adapted to attach directly to a projectile exit end 108 of firearm 104.

Ejection gases expand as they pass into and through projectile pathway 114. Much of the energy contained within this expansion, or explosion, will impinge upon an internal side of tube member 110. This energy will largely transfer to and through tube member 110 and will excite the air column defined by the geometry of tone generator 100. This air column will vibrate at frequencies and harmonics consistent with the geometry of the air column.

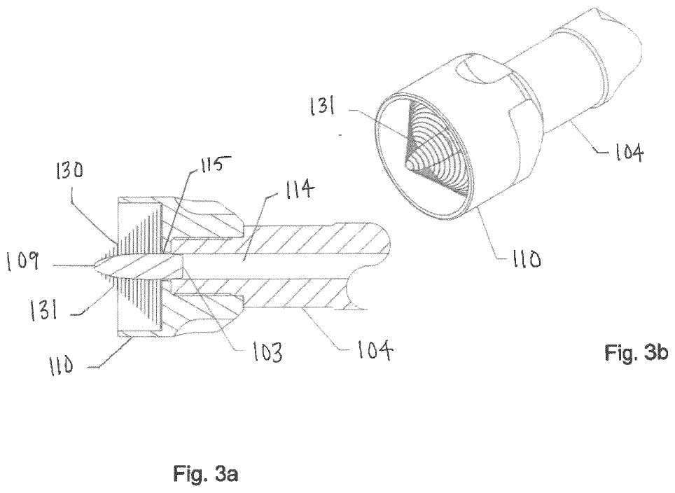

FIG. 3a depicts a longitudinal sectional view of an alternate embodiment of tone generator 100 creating supersonic shock wave propagation at a plurality of discrete points in a projectile pathway 114. FIG. 3b depicts a side perspective view of an alternate embodiment of tone generator 100 illustrating the transfer of energy of a supersonic shock wave 130 to cylindrical tube member 110. When a projectile 103 travels through projectile pathway 114 and exits a firearm 104 and then subsequently exits cylindrical tube member 110 of tone generator 100, said projectile 103 is traveling faster than the speed of sound, thereby creating supersonic shock wave propagation. A plurality of shockwaves 131 then expand in a substantially planar direction to a point of creation and normal to a line of the projectile pathway 114. As such, said shockwaves 131 begin at a tip of said projectile 103 and expand therefrom.

Energy then transfers through the medium and directly to the cylindrical tube member 110. The shock wave 130, created by projectile 103 moving at a rate of speed greater than the speed of sound for the medium within which it is moving, is created at every instant of supersonic movement of projectile 103 and propagates away from its source to transfer energy to the cylindrical tube member 110. The energy transferred to cylindrical tube member 110 causes said cylindrical tube member 110 to vibrate at its natural frequencies. The vibrating cylindrical tube member 110 will then excite the medium within cylindrical tube member 110 to create a standing wave within that medium.

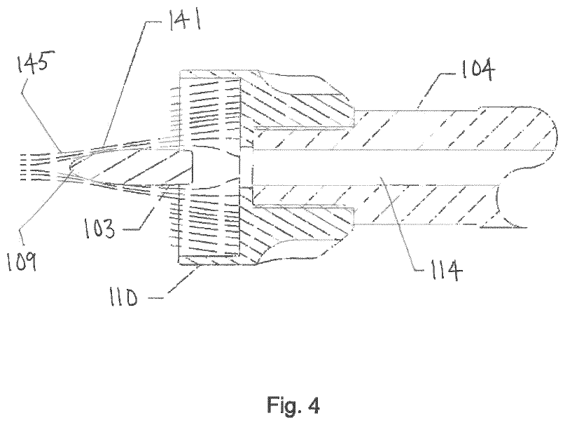

FIG. 4 depicts an alternate embodiment of tone generator 100 creating subsonic air compression 141 in a laminar flow of a projectile 103 in a compressible medium to cylindrical tube member 110. As projectile 103 moves through projectile pathway 114 and passes through the medium and cylindrical tube member 110, a variety of high pressures form near the projectile 103 as it displaces the medium. In this embodiment, projectile 103 travels at the speed of sound or slower. Energy then transfers through the medium and directly to the cylindrical tube member 110. The compressed medium 145 is created by an object moving through the medium and propagating from its source to transfer energy to cylindrical tube member 110. The energy transferred to cylindrical tube member 110 causes said cylindrical tube member 110 to vibrate at its natural frequencies. The vibrating cylindrical tube member 110 will then excite the medium within cylindrical tube member 110 to create a standing wave within that medium.

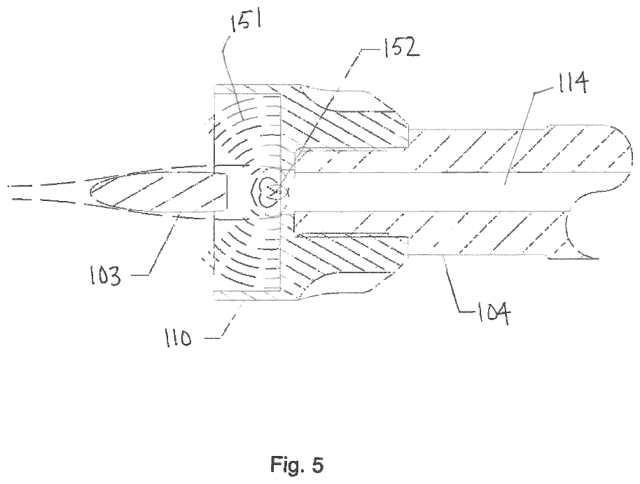

FIG. 5 depicts an alternate embodiment of tone generator 100 illustrating wake turbulence 151 and cavitation 152 in a medium caused by a passing projectile 103. Energy transfers through the medium and directly to cylindrical tube member 110. The phenomenon creates a compressive wave propagating from its source to transfer energy to the cylindrical tube member 110. The energy transferred to the cylindrical tube member 110 causes said cylindrical tube member 110 to vibrate at its natural frequencies. The vibrating cylindrical tube member 110 will excite the medium within cylindrical tube member 110 to create a standing wave in that medium.

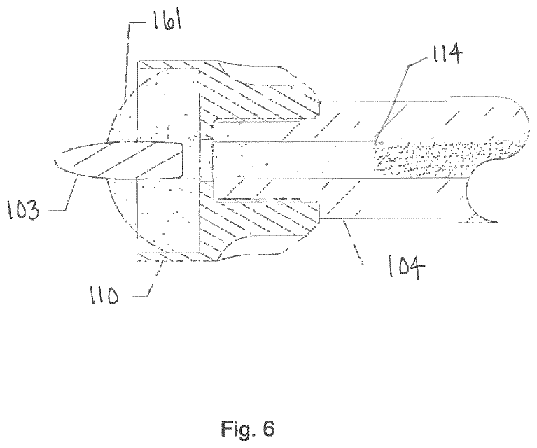

FIG. 6 depicts an alternate embodiment of tone generator 100 illustrating a plurality of rapidly expanding muzzle gases 161 within cylindrical tube member 110. Energy transfers through the medium and directly to cylindrical tube member 110. The phenomenon creates a compressive wave propagating from its source to transfer energy to cylindrical tube member 110. The energy transferred to cylindrical tube member 110 causes said cylindrical tube member 110 to vibrate at its natural frequencies. The vibrating cylindrical tube member 110 will then excite the medium within the cylindrical tube member 110 to create a standing wave within that medium.

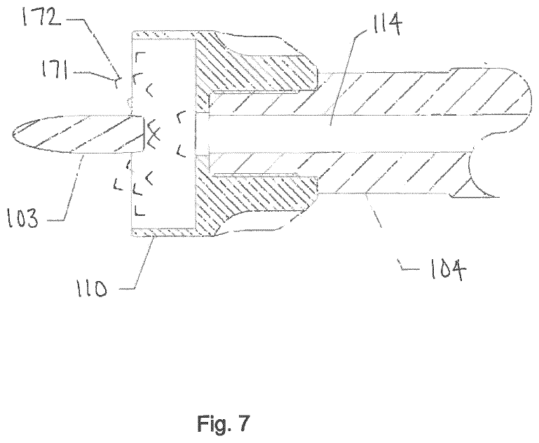

FIG. 7 depicts an alternate embodiment of tone generator 100 illustrating a plurality of particles 171 traveling at supersonic velocities and creating a plurality of individual shockwaves 172. Shockwaves 172 are created in the medium by a supersonic projectile 103 and other supersonic particles 171, such as unburned propellant particles, bullet and jacket shavings and cartridge materials, and coalescing liquid metal and vapors. Energy then transfers through the medium and directly to cylindrical tube member 110.

The shock waves 172, created by the particles 171 moving at a rate of speed greater than the speed of sound for the medium within which it is moving, are created at every instant of supersonic movement of projectile 103 and propagate away from its source to transfer energy to the cylindrical tube member 110. The energy transferred to the cylindrical tube member 110 causes said cylindrical tube member 110 to vibrate at its natural frequencies. The vibrating cylindrical tube member 110 will then excite the medium within the cylindrical tube member 110 to create a standing wave within that medium.

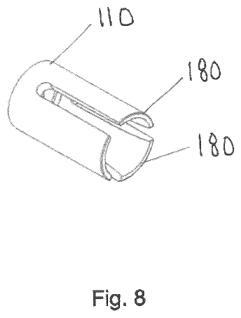

FIG. 8 depicts an alternate embodiment of cylindrical tube member 110 comprising a plurality of tines 180, wherein said tines 180 generate a variety of sounds for projection, amplifying or enhancing existing sounds, or canceling undesirable frequencies. Said tines 180 can be similar in length or differing lengths depending on the desired need and to generate or cancel sounds at specific frequencies. As the passing projectile 103 moves through projectile pathway 114 and exits said firearm 104 and then passes through and exits said cylindrical tube member 110, said tines 180 will vibrate, thereby generating a variety of sounds.

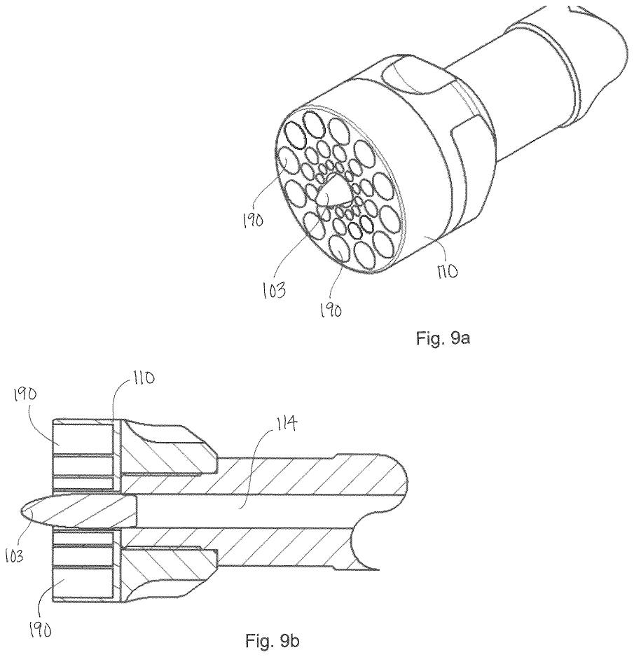

FIG. 9a depicts a perspective view of an alternate embodiment of cylindrical tube member 110 of tone generator apparatus 100 of the present invention comprising a plurality of cylinders 190. FIG. 9b depicts a longitudinal sectional view of an alternate embodiment of cylindrical tube member 110 of tone generator apparatus 100 of the present invention comprising a plurality of cylinders 190.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A tone generator apparatus for use in creating a vibration at a specific frequency range by using energy, such as energy generated by a firearm, wherein said tone generator apparatus comprises:
a) a tube member, having a first end, a second end, and an internal chamber, wherein said tube member is adapted to attachably connect to said firearm;
b) a projectile being launched by said firearm and moving through a projectile pathway and said internal chamber of said tube member; and
c) a medium located within said tube member, wherein said energy is transferred to said tone generator apparatus, thereby creating a resonant vibration within said medium.

2. The apparatus of claim 1, wherein said energy is a mechanical energy that is generated by launching said projectile within said firearm.

3. The apparatus of claim 1, wherein said energy is a shock wave energy that is generated by a supersonic projectile.

4. The apparatus of claim 1, wherein said energy is a mechanical energy that is transferred to a fluid medium by said projectile.

5. The apparatus of claim 1, wherein said energy is a mechanical energy that is generated by cavitation in a medium by said projectile.

6. The apparatus of claim 1, wherein said energy is a mechanical energy that is generated by a plurality of expanding muzzle gases.

7. The apparatus of claim 1, wherein said energy is a shock wave energy that is generated by a plurality of supersonic particles in a fluid suspension.

8. The apparatus of claim 1, further comprising a plurality of tines located on said tube member.
